(19) United States
(12) Patent Application Publication
(10) Pub. No.: US 2025/0147319 A1
(43) Pub. Date: May 8, 2025

(54) METASURFACE-BASED IMAGE COMBINER AND AUGMENTED REALITY DEVICE EMPLOYING SAME

(71) Applicant: SAMSUNG ELECTRONICS CO., LTD., Suwon-si (KR)

(72) Inventor: Jeonggeun YUN, Suwon-si (KR)

(73) Assignee: SAMSUNG ELECTRONICS CO., LTD., Suwon-si (KR)

(21) Appl. No.: 19/016,506

(22) Filed: Jan. 10, 2025

Related U.S. Application Data
(63) Continuation of application No. PCT/KR2023/009349, filed on Jul. 3, 2023.

(30) Foreign Application Priority Data
Jul. 21, 2022 (KR) 10-2022-0090575
Jan. 27, 2023 (KR) 10-2023-0011223

(51) Int. Cl. G02B 27/01

(52) U.S. Cl. CPC G02B 27/0172

(57) ABSTRACT

Provided is an image combiner including a waveguide, an input-coupling element, in an input-coupling area of the waveguide, configured to input light of a virtual image incident on the input-coupling area into the waveguide, and a folding/output-coupling element, in a folding/output-coupling area of the waveguide, configured to form an eye box by outputting the light input into the waveguide out of the waveguide, wherein the folding/output-coupling element is an anisotropic metasurface including a first sub-metasurface and a second sub-metasurface in a first sub-area and a second sub-area, and wherein the anisotropic metasurface is configured such that among rays input through different areas of the input-coupling area, a first ray having a first incidence angle is diffracted by the first sub-metasurface to be directed to the eye box and a second ray having a second incidence angle is diffracted by the second sub-metasurface to be directed to the eye box.

### CROSS-REFERENCE TO RELATED APPLICATIONS

This application is a bypass continuation of International Application No. PCT/KR2023/009349, filed on Jul. 3, 2023, which is based on and claims priority to Korean Patent Application No. 10-2022-0090575, filed on Jul. 21, 2022, and Korean Patent Application No. 10-2023-0011223, filed on Jan. 27, 2023, in the Korean Intellectual Property Office, the disclosures of which are incorporated by reference herein in their entireties.

### BACKGROUND

### 1. Field

The disclosure relates to a metasurface-based image combiner and an augmented reality device employing the same.

### 2. Description of Related Art

An augmented reality (AR) device is a device through which AR may be viewed, and includes, for example, AR glasses. An optical imaging system of the AR device includes an image generator for generating an image and an image combiner for sending the generated image to the eye. The AR device is required to have a wide viewing angle and high-quality images, and the device itself be lightweight and compact.

For recent AR devices such as the AR glasses, a waveguide based optical system for the image combiner is being studied and developed. The traditional waveguide-type image combiner uses free-form reflection or multi-mirror reflection or uses a diffractive optical element (DOE) or holographic optical element (HOE) to input or expand/output light.

### SUMMARY

According to an aspect of the disclosure, there is provided an image combiner including a waveguide, an input-coupling element, in an input-coupling area of the waveguide, configured to input light of a virtual image incident on the input-coupling area into the waveguide, and a folding/output-coupling element, in a folding/output-coupling area of the waveguide, configured to form an eye box by outputting the light input into the waveguide out of the waveguide, wherein the folding/output-coupling element is an anisotropic metasurface including a first sub-metasurface and a second sub-metasurface in a first sub-area and a second sub-area of the folding/output-coupling area, respectively, and wherein the anisotropic metasurface is configured such that among rays input through different areas of the input-coupling area, a first ray having a first incidence angle is diffracted by the first sub-metasurface to be directed to the eye box and a second ray having a second incidence angle, which is different from the first incidence angle, is diffracted by the second sub-metasurface to be directed to the eye box.

The first sub-metasurface may include an array of a plurality of first nanostructures at a first rotation angle in the first sub-area, the second sub-metasurface may include an array of a plurality of second nanostructures at a second rotation angle, which is different from the first rotation angle, in the second sub-area, and the first rotation angle and the second rotation angle respectively may determine a dominant diffraction order of the first ray diffracted in the first sub-area and a dominant diffraction order of the second ray diffracted in the second sub-area.

The plurality of first nanostructures and the plurality of second nanostructures may be nanorods on the first sub-area and the second sub-area, respectively.

The first sub-metasurface may include an array of a plurality of first nanostructures in the first sub-area, the second sub-metasurface may include an array of a plurality of second nanostructures in the second sub-area, and a size of each first nanostructure of the plurality of first nanostructures and a size of each second nanostructure of the plurality of second nanostructures may be determined such that brightness in the first sub-area is equal to brightness in the second sub-area.

An optical propagation length of a ray with the first incidence angle in the waveguide may be shorter than an optical propagation length of a ray with the second incidence angle in the waveguide, and a diffraction efficiency of the first sub-area may be higher than a diffraction efficiency of the second sub-area.

The first sub-area may be nearer to the input-coupling element than the second sub-area.

The folding/output-coupling element may include a plurality of sub-metasurfaces, and at least one sub-metasurface of the plurality of sub-metasurfaces may be a folding coupling element configured to transmit light input into the waveguide to sub-metasurfaces other than the at least one sub-metasurface of the plurality of sub-metasurfaces.

The folding/output-coupling area may include a plurality of sub-areas, and at least one sub-area of the plurality of sub-areas may have a different form than sub-areas other than the at least one sub-area of the plurality of sub-areas.

The folding/output-coupling element may include a plurality of sub-metasurfaces, and at least one of a rotation angle, a width, and a length of nanostructures of the plurality of sub-metasurfaces may be gradually changed.

The anisotropic metasurface may be formed of at least one of a-Si, a-Si:H, TiO2, and GaN.

The first incidence angle may be an incidence angle of a ray having an optical propagation length that is longer than optical propagation lengths among rays input to and propagated in the waveguide, and the second incidence angle may be an incidence angle of a ray having a optical propagation length that is shorter than optical propagation lengths among the rays input to and propagated in the waveguide.

The input-coupling element may have a maximum diffraction efficiency for polarized light in a first direction from the first ray with the first incidence angle and may have a maximum diffraction efficiency for polarized light in a second direction perpendicular to the first direction from the second ray with the second incidence angle, and the first sub-metasurface may have a maximum diffraction efficiency for the polarized light in the first direction, and the second sub-metasurface may have a maximum diffraction efficiency for the polarized light in the second direction.

The input-coupling element may be an irregular metasurface including a plurality of irregular unit structures periodically on a two-dimensional (2D) plane, each irregular unit structure of the plurality of irregular unit structures having a non-periodic irregular pattern.

According to an aspect of the disclosure, there is provided an augmented reality (AR) device including a display engine configured to output light of an image, and an image combiner including a waveguide, an input-coupling element, in an input-coupling area of the waveguide, configured to input light of a virtual image incident on the input-coupling area into the waveguide, and a folding/output-coupling element, in a folding/output-coupling area of the waveguide, configured to form an eye box by outputting the light input into the waveguide out of the waveguide, wherein the folding/output-coupling element is an anisotropic metasurface including a first sub-metasurface and a second sub-metasurface in a first sub-area and a second sub-area of the folding/output-coupling area, respectively, and wherein the anisotropic metasurface is configured such that among rays input through different areas of the input-coupling area, a first ray having a first incidence angle is diffracted by the first sub-metasurface to be directed to the eye box and a second ray having a second incidence angle, which is different from the first incidence angle, is diffracted by the second sub-metasurface to be directed to the eye box, wherein the image combiner is configured to guide the light output from the display engine into a target area that is the eye box.

The AR device may include AR glasses including a left-eye element and a right-eye element corresponding to left and right eyes of a user, respectively, and each of the left-eye element and the right-eye element may include the display engine and the image combiner.

The first sub-metasurface may include an array of a plurality of first nanostructures at a first rotation angle in the first sub-area, the second sub-metasurface may include an array of a plurality of second nanostructures at a second rotation angle, which is different from the first rotation angle, in the second sub-area, and the first rotation angle and the second rotation angle respectively may determine a dominant diffraction order of the first ray diffracted in the first sub-area and a dominant diffraction order of the second ray diffracted in the second sub-area.

The plurality of first nanostructures and the plurality of second nanostructures may be nanorods on the first sub-area and the second sub-area, respectively.

The first sub-metasurface may include an array of a plurality of first nanostructures in the first sub-area, the second sub-metasurface may include an array of a plurality of second nanostructures in the second sub-area, and a size of each first nanostructure of the plurality of first nanostructures and a size of each second nanostructure of the plurality of second nanostructures may be determined such that brightness in the first sub-area is equal to brightness in the second sub-area.

An optical propagation length of a ray with the first incidence angle in the waveguide may be shorter than an optical propagation length of a ray with the second incidence angle in the waveguide, and a diffraction efficiency of the first sub-area may be higher than a diffraction efficiency of the second sub-area.

The first sub-area may be nearer to the input-coupling element than the second sub-area.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a schematic configuration of an image combiner, according to one or more embodiments;

FIG. 2 illustrates a layout of a metasurface in an image combiner, according to one or more embodiments;

FIG. 3 illustrates a configuration of an input-coupler, according to one or more embodiments;

FIG. 4 is a plan view illustrating an irregular unit structure, according to one or more embodiments;

FIG. 5 is a perspective view illustrating irregular unit structures, according to one or more embodiments;

FIG. 6 schematically illustrates a method of designing an irregular metasurface, according to one or more embodiments;

FIG. 7 is a diagram for describing forward simulation in a process of calculating an irregular metasurface;

FIG. 8 is a diagram for describing adjoint simulation in the process of calculating an irregular metasurface;

FIG. 9 is a diagram for describing binarization on an irregular unit structure of an irregular metasurface, according to one or more embodiments;

FIG. 10 is a plan view illustrating a configuration of a unit cell of a sub-metasurface, according to one or more embodiments;

FIG. 11 is a perspective view illustrating a configuration of a unit cell of a sub-metasurface, according to one or more embodiments;

FIG. 12 is a plan view for describing operation of an image combiner, according to one or more embodiments;

FIG. 13 is an enlarged view of area D and its vicinity of FIG. 12;

FIG. 14 is a side view for describing operation of an image combiner, according to one or more embodiments;

FIG. 15 illustrates a configuration of a folding/output-coupling element, according to one or more embodiments;

FIG. 16 illustrates a configuration of a folding/output-coupling element, according to one or more embodiments;

FIG. 17 illustrates a configuration of a folding/output-coupling element, according to one or more embodiments;

FIG. 18 is a graph showing diffraction efficiency of an image combiner, according to one or more embodiments; and

FIG. 19 schematically illustrates augmented reality (AR) glasses, according to one or more embodiments.

### DETAILED DESCRIPTION

Embodiments of the disclosure will now be described with reference to accompanying drawings to assist those of ordinary skill in the art in readily implementing them. However, the embodiments of the disclosure may be implemented in many different forms, and not limited thereto as will be discussed herein. In the drawings, parts unrelated to the description are omitted for clarity, and like numerals refer to like elements throughout the specification.

The terms are selected from among common terms widely used at present, taking into account principles of the disclosure, which may however depend on intentions of those of ordinary skill in the art, judicial precedents, emergence of new technologies, and the like. Some terms as herein used are selected at the applicant's discretion, in which case, the terms will be explained later in detail in connection with embodiments of the disclosure. Therefore, the terms should be defined based on their meanings and descriptions throughout the disclosure.

It is to be understood that the singular forms “a,” “‘an,” and “the” include plural references unless the context clearly dictates otherwise. The term “include (or including)” or “comprise (or comprising)” is inclusive or open-ended and does not exclude additional, unrecited elements or method steps, unless otherwise mentioned.

Throughout the specification, the term anisotropic metasurface refers to a metasurface on which (anisotropic) rectangular nano-rods whose length is equal to or greater than the width (i.e., satisfying length≥width) constitute a unit cell.

In the present disclosure, the term viewing angle refers to a viewing range and angle when the user views a virtual image through an image combiner. The viewing angle is limited by the projection angle of light output from a display engine and projected onto an input-coupling element and optical performance of the image combiner. The projection angle from the display engine corresponds to an incidence angle at the input-coupling element. Light incident on the input-coupling element at a certain incidence angle is diffracted at a certain diffraction angle, so the incidence angle has a corresponding relation with the diffraction angle. Accordingly, throughout the specification, the projection angle from the display engine, the incidence angle at the input-coupling element, and the diffraction angle may be interchangeably used, and the range of the angle may correspond to a range of the viewing angle.

In the present disclosure, the term optical propagation length refers to a distance light propagates within a waveguide through total internal reflection in the waveguide. The optical propagation length of the light that propagates in the waveguide may vary depending on the diffraction angle at which the light is diffracted when input into the waveguide.

The disclosure will now be described with reference to accompanying drawings.

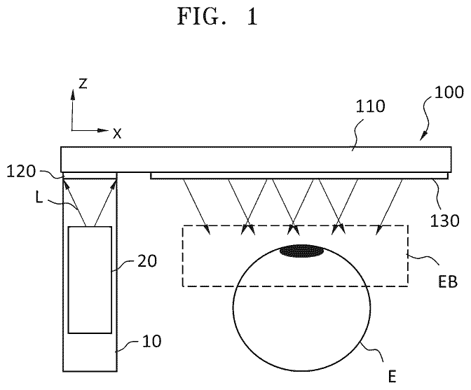

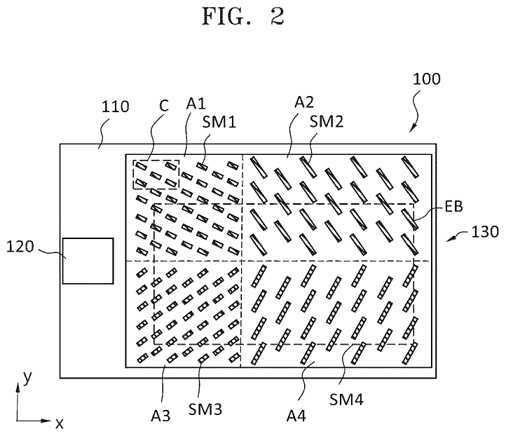

FIG. 1 schematically illustrates an image combiner 100, according to one or more embodiments, and FIG. 2 illustrates a layout of an input-coupling element 120 and a folding/output-coupling element 130 in the waveguide 110, in one or more embodiments.

Referring to FIGS. 1 and 2, the image combiner 100 may include the waveguide 110, the input-coupling element 120 and the folding/output-coupling element 130.

The waveguide 110 is a device that propagates the incident light through total internal reflection. The waveguide 110 may be a plate-type member including one surface and the other surface opposite the one surface. Although the waveguide 110 is shown in FIG. 1 as a flat plate-type member, the waveguide 110 may be a curved plate-type member. The waveguide 110 is shown as having a rectangular shape in FIG. 2, but is not limited thereto.

The waveguide 110 may be formed of a material which is transparent at a wavelength of light at which the input-coupling element 120 and the folding/output-coupling element 130 operate. For example, the waveguide 110 may be formed of glass or a polymer material with a transmittance of greater than or equal to 90% in the visible light spectrum, but is not limited thereto.

As the waveguide 110 is formed of a material transparent at the visible light spectrum, the light may be penetrated in the direction of thickness of the waveguide 110. Accordingly, the user is able to see a real scene outside the waveguide 110 through the waveguide 110. According to one or more embodiments, an optical element that blocks penetration of the light of the real scene or controls an amount of the transmitted light of the real scene according to an electric signal may also be arranged at the waveguide 110.

A display engine 20 may be arranged on one side of a surface of the waveguide 110 to allow light L of a virtual image output from the display engine 20 to be incident on one side of the surface of the waveguide 110. In one or more embodiments, the image combiner 100 may be applied to, for example, augmented reality (AR) glasses, in which case, the display engine 20 may be arranged, but not exclusively, on a leg 10 of the AR glasses.

The input-coupling element 120 is a device for coupling the light L of the virtual image output from the display engine 20 to the waveguide 110, i.e., inputting the light L into the waveguide 110. The input-coupling device 120 may be a diffraction element for diffracting the light L of the virtual image incident on the waveguide 110 to be input into the waveguide 110.

In one or more embodiments, the input-coupling element 120 may be formed with an irregular metasurface. The irregular metasurface may be formed with irregular unit structures periodically arranged on a two-dimensional (2D) surface, the irregular unit structure comprised of multiple nanostructures irregularly arranged.

The related diffractive optical element or holographic optical element has relatively low diffraction efficiency for relatively large diffraction angles due to their material and physical properties, but according to one or more embodiments, the irregular metasurface of the input-coupling element 120 may have an increased diffraction efficiency for the relatively large diffraction angle, which may contribute to securing a relatively wide horizontal viewing angle.

In one or more embodiments, the irregular metasurface of the input-coupling element 120 may be optimized by applying a weight according to the incidence angle and polarization of the incident light L. A more detailed configuration of the irregular metasurface of the input-coupling element 120 will be described later.

The folding/output-coupling element 130 is a device that performs eye box expansion of the light L of the virtual image propagated in the waveguide 110 and outputs the light L out of the waveguide 110. The eye box EB refers to an area where an image projected by the image combiner 100 may be maintained clearly.

An area where the folding/output-coupling element 130 is arranged (hereinafter, a folding/output coupling area) is divided into a first sub-area A1, a second sub-area A2, a third sub-area A3, and a fourth sub-area A4, and a first sub-metasurface SM1, a second sub-metasurface SM2, a third sub-metasurface SM3, and a fourth sub-metasurface SM4 are formed with anisotropic nanorods on the first to fourth sub-areas A1, A2, A3 and A4. In other words, the first to fourth sub-metasurfaces SM1, SM2, SM3 and SM4 constitute an anisotropic metasurface. The term anisotropic may indicate that the first to fourth sub-metasurfaces SM1, SM2, SM3 and SM4 constitute a unit cell with (anisotropic) rectangular nanorods that satisfy length≥width. The first to fourth sub-metasurfaces SM1, SM2, SM3 and SM4 may differ in at least one of the diffraction direction, diffraction efficiency and polarization selectivity of a dominant diffraction order by varying at least one of the shape and arrangement of the nanostructures.

In one or more embodiments, the first to fourth sub-metasurfaces SM1, SM2, SM3 and SM4 may be configured for diffracted light to be directed to the eye box EB. For example, in FIG. 2, the first sub-metasurface SM1 is configured to output diffracted light at the dominant diffraction order toward the lower right, the second sub-metasurface SM2 is configured to output diffracted light at the dominant diffraction order toward the lower left, the third sub-metasurface SM3 is configured to output diffracted light at the dominant diffraction order toward the upper right and the fourth sub-metasurface SM4 is configured to output diffracted light at the dominant diffraction order toward the upper left, to suppress light that does not contribute to forming the eye box EB but is lost among the light L output by the folding/output-coupling element 130 and secure a wide horizontal viewing angle.

In one or more embodiments, the second and fourth sub-metasurfaces SM2 and SM4 on far sides farther away from the input-coupling element 120 among the first to fourth sub-metasurfaces SM1, SM2, SM3 and SM4 than the first and third sub-metasurfaces SM1 and SM3 are configured to have higher diffraction efficiency than the first and third sub-metasurfaces SM1 and SM3 on near sides nearer to the input-coupling element 120, thereby making the brightness of the virtual image displayed by the image combiner 100 uniform.

The light L propagated in the waveguide 110 is diffracted several times within the waveguide 110 and exits the waveguide 110 to form the eye box EB, in which case diffracted light at a smaller diffraction angle has relatively long optical propagation length and is thus propagated to the folding/output-coupling element 130 by being diffracted more times as compared to diffracted light at a relatively larger diffraction angle, and the relatively thinner the waveguide 110, the relatively larger the number of times of being diffracted. Furthermore, in one or more embodiments, the image combiner 100 may have thinner waveguide 110 while satisfying the uniformity of brightness due to the anisotropic metasurface of the folding/output-coupling element 130.

In the one or more embodiments, the image combiner 100 is employed by a near-eye display apparatus and the eye of the user who is using the near-eye display apparatus is located adjacent to the image combiner 100, so a sufficient size of the eye box EB needs to be secured by considering a wearing condition or eye movement of the user during the actual use. In the one or more embodiments, the wearing condition and eye movement of the user may be dealt with by securing a sufficient size of the eye box EB by using the irregular metasurface of the input-coupling element 120 and the anisotropic metasurface of the folding/output-coupling element 130.

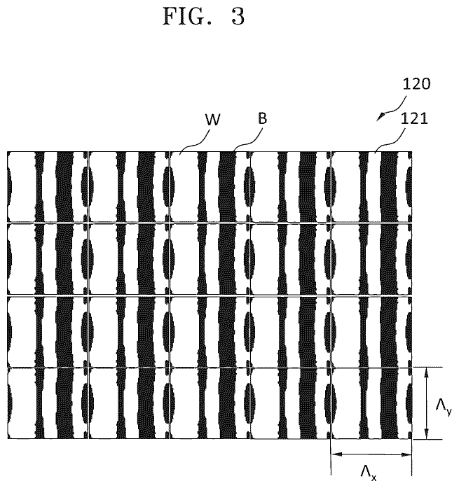

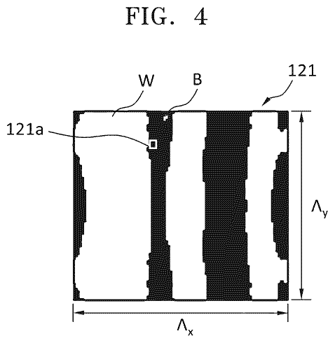

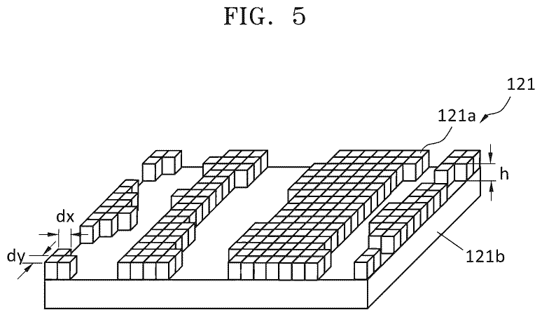

FIG. 3 is a plan view illustrating a schematic configuration of the input-coupling element 120, according to one or more embodiments, FIG. 4 is a plan view schematically illustrating an irregular unit structure 121, according to one or more embodiments, and FIG. 5 is a perspective view schematically illustrating the irregular unit structure 121, according to one or more embodiments.

Referring to FIGS. 3 to 5, the irregular metasurface of the input-coupling element 120 includes a plurality of irregular unit structures 121. The plurality of irregular unit structures 121 may have the same structure and may be periodically arranged on a 2D surface. The irregular unit structures 121 may constitute the irregular metasurface and may be understood as minimum unit cells that are arranged regularly.

The irregular metasurface of the input-coupling element 120 may be formed of a dielectric material having a high refractive index to increase complex amplitude controllability by maximizing interactions with the incident light. For example, the irregular metasurface of the input-coupling element 120 may be formed of a-Si, a-Si:H, TiO₂, GaN, etc.

The irregular unit structures 121 may have a width of Λₓ in the x direction and a width of Λ_{y} in the y direction, and may be arranged at an interval of Λₓ in the x direction and Λ_{y} in the y direction. The widths Λₓ and Λ_{y} of the irregular unit structure 121 may each have a value (i.e., of sub-wavelength) smaller than or similar to the operating wavelength of the incident light (operating wavelength of the metasurface). For example, the widths Λₓ and Λ_{y} of the irregular unit structure 121 may have a few hundred nanometers (nm) in the visible ray spectrum. The width of Λₓ in the x direction and the width of Λ_{y} in the y direction of the irregular unit structure 121 may be different or the same. The irregular unit structure 121 may have a structure with relatively high refractive dielectrics of a certain thickness h formed in an irregular pattern.

In FIG. 4, dark areas B are the high refractive dielectric areas, and the other areas W may be understood as air areas. The irregular pattern of the irregular unit structure 121 may be implemented with nanostructures 121a, which are high refractive dielectrics, arranged irregularly on a transparent substrate 121b as shown in FIG. 5. For example, the irregular unit structure 121 may be manufactured in a method of etching or imprinting the high refractive dielectrics in an irregular pattern in which the area with the width of Λₓ in the x direction and the width of Λ_{y} in the y direction is divided into grids, each grid having widths of dx and dy and being filled with the dielectric or empty. The area of the high refractive dielectrics (i.e., the dark area) B in FIG. 4 may be implemented with a set of nanostructures 121a and the other area W may be understood as an empty area without the nanostructures 121a. The related metasurface may be implemented with nanostructures such as nanorods arranged periodically or implemented with lattices of a sub-wavelength size, which may be understood as a typical metasurface. On the other hand, the irregular unit structure 121 of the one or more embodiments may be implemented with aperiodic arrangement or irregular patterns of the nanostructures 121a.

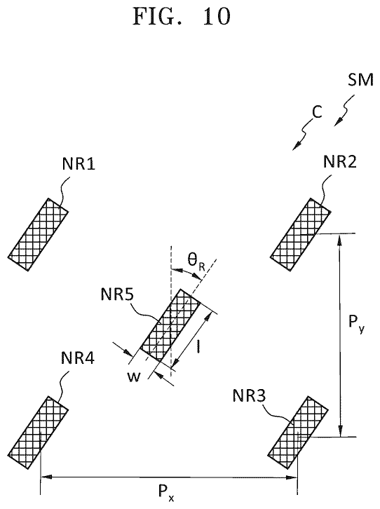

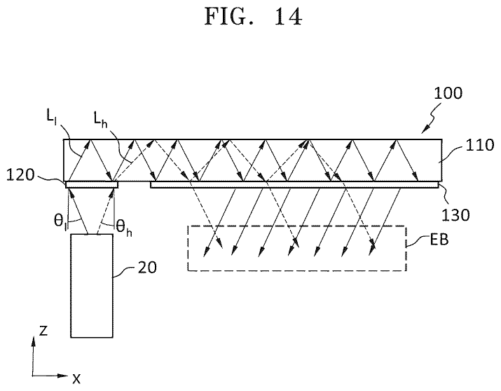

In one or more embodiments, the irregular metasurface of the input-coupling element 120 may be optimized by applying a weight according to the incidence angle and polarization of the incident light L. For example, the irregular metasurface of the input-coupling device 120 may be optimized such that for light with short optical propagation length (light Lₕ of incidence angle θₕ in FIG. 14), x-axis polarized light has a maximum diffraction efficiency and for light with long propagation length (light Lₗ of incidence angle θₗ in FIG. 10), y-axis polarized light has a maximum diffraction efficiency.

In one or more embodiments, the irregular metasurface of the input-coupling device 120 may be manufactured with a separate metasurface film and attached to the waveguide 110, without being limited thereto. In another example, the irregular metasurface of the input-coupling device 120 may be formed (e.g., etched or imprinted) directly on a surface of the waveguide 110 in a metasurface pattern. In another example, the irregular metasurface of the input-coupling element 120 may be arranged inside the waveguide 110.

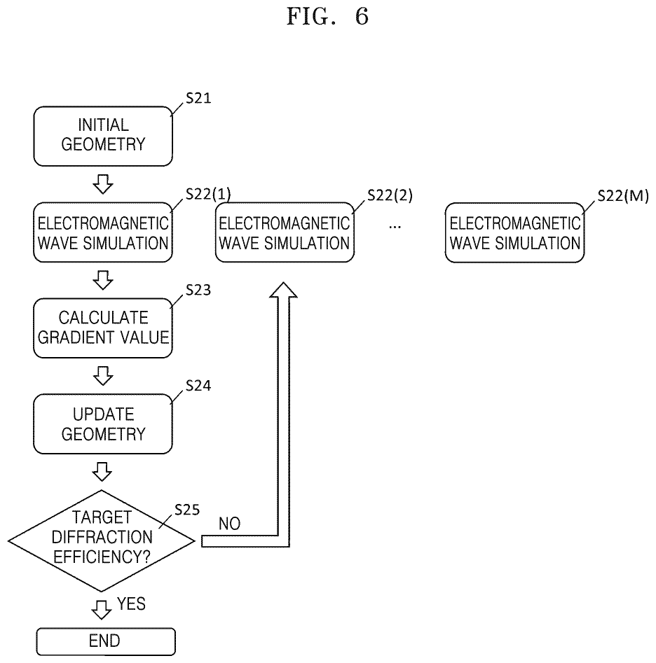

FIG. 6 schematically illustrates a method of designing an irregular metasurface, according to one or more embodiments.

Referring to FIG. 6, considered is the irregular unit structure 121 having widths Λₓ and Λ_{y}. The irregular metasurface is formed with the irregular unit structures 121 each having the widths Λₓ and Λ_{y} repeatedly arranged. The widths Λₓ and Λ_{y} of the unit structure on the irregular metasurface may be determined as follows: A propagation angle of the light L in the waveguide 110 (of FIG. 1) is determined based on the incidence angle θᵢₙ of light incident onto the input-coupling element 120 (i.e., the irregular metasurface) and periodicity of the input-coupling element 120 according to [Equation 1] below:

$${n}_{g} = sin {θ}_{out} - {n}_{a} sin {θ}_{m} = m \frac{λ}{Λ} \qquad [ Equation 1 ]$$

Here, λ denotes a target operating wavelength of the irregular metasurface to be designed, n_{g} denotes a refractive index of the waveguide 110, nₐ denotes a refractive index of air, and m denotes a target diffraction order. For example, when λ=660 nm, n_{g}=1.7 (for glass substrate) and nₐ=1, it needs to be set that Λ_{y}=/n_{g}=375 nm to prevent diffraction in the direction of the y axis, and Λₓ is calculated using equation 1 and may be set to Λₓ=500 nm when the periodicity is designed such that the angle of the +1st diffracted light is 51° in the x direction with respect to 0° incidence for a wide viewing angle.

For initial geometry D₀ satisfied by the irregular unit structure 121, an arbitrary refractive index distribution satisfying nₐ≤n≤n_{di} is set, in operation S21. nₐ denotes a refractive index of air, and n_{di} denotes a refractive index of the dielectric that constitutes the irregular metasurface. The dielectric distribution may be deemed the refractive index distribution, and the geometry of the irregular metasurface may be defined from the refractive index distribution. Patterns of the unit structure of the final irregular metasurface may be variously calculated (obtained) according to the initial refractive index distribution.

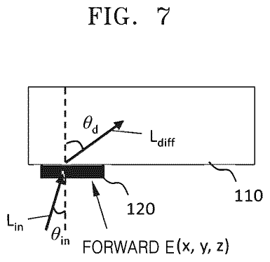

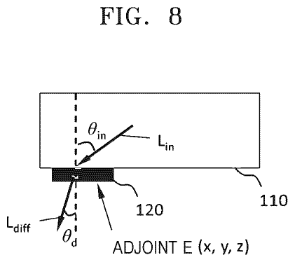

Subsequently, diffraction efficiency at the target diffraction order on the irregular metasurface having the initial refractive index distribution D₀ is calculated in operation S22(1). The target refraction order may be, for example, the first diffraction order. FIG. 7 is a diagram for describing forward simulation in the calculation process of an irregular metasurface, and FIG. 8 is a diagram for describing adjoint simulation in the calculation process of an irregular metasurface. As shown in FIG. 7, as m different incident rays Lᵢₙ are diffracted on the irregular metasurface (i.e., the input-coupling element 120) having a refractive index distribution of D₀ with respect to the incidence angle θi of the incident light Lᵢₙ and the diffracted light L_{diff} is input into the waveguide 110, a forward electric field distribution E(x, y, z) in the waveguide 110 may be calculated by forward simulation. Similarly, as the light Lᵢₙ incident on the irregular metasurface from inside the waveguide 110 is diffracted on the irregular metasurface and the diffracted light L_{diff} exits from the waveguide 110, an adjoint electric field distribution E(x, y, z) in the waveguide 110 may be calculated by adjoint simulation. Using the forward simulation and the adjoint simulation, diffraction efficiency at the target diffraction order on the irregular metasurface may be calculated. The incident light Lᵢₙ is incident from a 3D space, so the incidence angle θi of the incident light Lᵢₙ may be given as a function of the azimuthal angle and the polar angle.

Next, a refractive index gradient G(x, y, z) that represents a change in diffraction efficiency at the target diffraction order due to a change in refraction index of each position on the metasurface is calculated in operation S23. The refractive index gradient G(x, y, z) may be calculated by the following [Equation 2] below:

$$G ( x , y , z ) = \frac{δ FoM}{δ ε} \qquad [ Equation 2 ]$$

Here, FoM denotes diffraction efficiency at the target diffraction order, and ε denotes a refraction index.

The refraction index gradient may be calculated as in the following [Equation 3] below using the values calculated in the forward simulation E and the adjoint simulation E^{A}.

$$\frac{δ FoM}{δ ε} ∝ Re [ E \cdot {E}^{A} ] \qquad [ Equation 3 ]$$

In this case, to make an irregular metasurface that operates in a wide viewing angle, a weighted average of refractive index gradients with respect to M incidence angles θᵢ is obtained as in the following [Equation 4] below:

$${\sum }_{i = 1}^{M} {a}_{i} \times Re [ E ( {θ}_{i} ) \cdot {E}^{A} ( {θ}_{i} ) ] \qquad [ Equation 4 ]$$

Here, M denotes an integer equal to or greater than 2, and aᵢ is a weight constant. The weight constant has influence on the diffraction efficiency at the target diffraction order of the irregular metasurface through optimization. For example, an appropriate weight distribution may make the diffraction efficiency of the irregular metasurface equal depending on the incidence angle. Each weight constant may be determined by taking into account the diffraction efficiency at the target diffraction order of the irregular metasurface depending on the incidence angle θᵢ. For example, by increasing the weight constant for an incidence angle having low diffraction efficiency, the diffraction efficiency of the final irregular metasurface may be uniformized. For example, for incident rays having different incidence angles due to interference of Bloch modes, it operates to have uniformly high diffraction efficiency at the target diffraction order.

Next, the geometry (i.e., the refractive index distribution D₀) of the irregular metasurface is updated by multiplying the refractive index gradient G calculated on the irregular metasurface by an appropriate learning rate constant q in operation S24 as in the following [Equation 5] below:

$${D}_{0} \to {D}_{0} + q G \qquad [ Equation 5 ]$$

The updating of the geometry includes binarization that makes the refractive index distribution having values of nₐ<n<n_{di} be nₐ or n_{di} in order to have the final structure of the irregular metasurface formed of air and dielectrics. In one or more embodiments, the updating of the geometry may further include filtering such as Gaussian filtering to ensure manufacturability and robustness of the irregular metasurface.

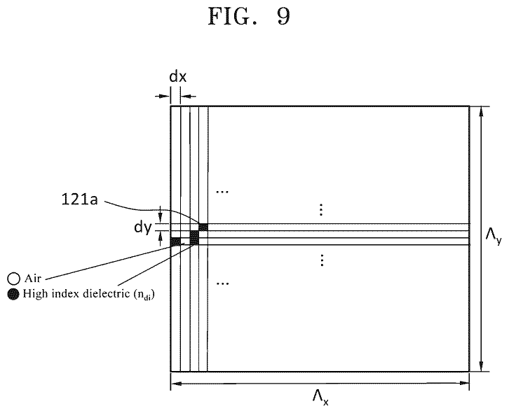

FIG. 9 is a diagram for describing binarization in a unit cell of an irregular metasurface, according to one or more embodiments. Referring to FIG. 9, the unit structure having widths Λₓ and Λ_{y} is divided into grids, and each grid area is empty without or filled with a high refractive dielectric. For example, the widths Λₓ and Λ_{y} may be hundreds of nm as described above, and the widths dx and dy may have a sub-wavelength size of about tens of nm or 10 nm or less. The horizontal width dx and the vertical width dy may be the same or different. The gird areas may be shaped like a square, a rectangle, a circle, a polygon, etc., without being limited thereto.

The binarized unit structure of the irregular metasurface may be understood as a set of nanostructures 121a. Each nanostructure 121a may be, for example, a column with widths dx and dy and height h (see FIG. 5), but is not limited thereto. The height h of each nanostructure 121a may be smaller than an operating wavelength of the incident light. For example, the height h of each nanostructure 121a may be about λ/n_{di}. λ is an operating wavelength of the incidence light, and n_{di} refers to a refractive index of the irregular unit structure 121. For example, the height h of the nanostructure 121a may have a thickness of tens of nm to hundreds of nm in the visible light spectrum. Each of the widths dx and dy of the nanostructure 121a may have a size of about tens of nm or less than or equal to 10 nm. The horizontal width dx and the vertical width dy of each nanostructure 121a may be the same or different. Each nanostructure 121a may have the form of e.g., a square column, a rectangular column, a circular column, or a polygonal column, without being limited thereto.

Whether the diffraction efficiency at the target diffraction order of the updated irregular metasurface is converged is determined in operation S25, and operations S22 to S24 are repeated in operation S24 until the diffraction efficiency at the target diffraction order of the updated irregular metasurface is converged to a target diffraction efficiency. For example, the light diffracted on the irregular metasurface is computed by the forward simulation and the adjoint simulation based on the updated geometry (i.e., the refractive index distribution) of the irregular metasurface, using this, diffraction efficiency at the target diffraction order of the irregular metasurface is calculated in operation S22(2), a refractive index gradient is calculated in operation S23, and based on this, the geometry (i.e., the refractive index distribution) of the irregular metasurface is updated again. The binarization operation does not need to be always performed in the repetitive process of operations S22 to S24 in updating the geometry.

The geometry of the irregular metasurface updated in the aforementioned method has a binarized refractive index distribution, so the irregular metasurface may be manufactured in such a method as etching or imprinting a high refractive dielectric with a binarized refractive index distribution. Etching or imprinting may use a related manufacturing method, so the description thereof will be omitted.

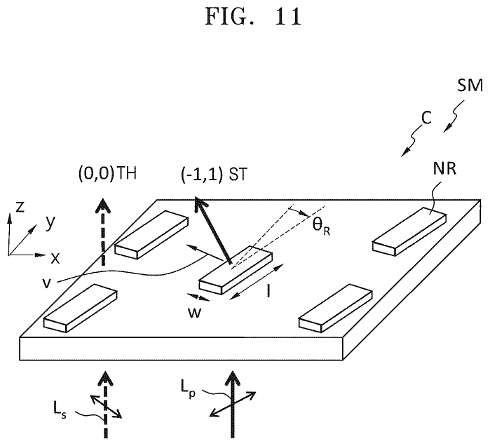

FIG. 10 illustrates a schematic configuration of a unit cell C of a sub-metasurface SM, according to one or more embodiments, and FIG. 11 is a diagram for describing operation in the unit cell C of the sub-metasurface SM, according to one or more embodiments. The unit cell C shown in FIG. 10 may be repetitively arranged on a 2D surface to form one of the first to fourth sub-metasurfaces SM1, SM2, SM3 and SM4 of FIG. 2.

Referring to FIGS. 10 and 11, the unit cell C of the sub-metasurface SM may be formed with nanorods NR1, NR2, NR3, NR4 and NR5 arranged on a 2D surface. A plurality of unit cells C may be arranged with periodicity Px and Py in the x and y directions to form the sub-metasurface SM. For example, the unit cell C may be formed with five nanorods NR1, NR2, NR3, NR4 and NR5 arranged at four corners and a center, without being limited thereto. Each nanorod NR1, NR2, NR3, NR4 or NR5 may have the form in which the length l is equal to or larger than the width w (i.e., l≥w) and have a certain rotation angle θ_{R}. For example, each nanorod NR1, NR2, NR3, NR4 or NR5 may have a length l of about tens of nm to hundreds of nm and a width w of about tens of nm or less than or equal to 10 nm.

The nanorods NR1, NR2, NR3, NR4 and NR5 in one sub-metasurface SM may all have the same length l, width w and rotation angle θ_{R}. At least one of length l, width w and rotation angle θ_{R} of the nanorods NR1, NR2, NR3, NR4 and NR5 belonging to a different sub-metasurface may be different.

The nanorods NR1, NR2, NR3, NR4 and NR5 make different electromagnetic resonances with light depending on the polarization direction of the incident light L. Light Lₚ of a polarization component in a direction corresponding to a direction of the major axis (i.e., the length direction) of the nanorods NR1, NR2, NR3, NR4 and NR5 makes strong electromagnetic resonance. Light Lₚ of a polarization component in a direction corresponding to a direction of the minor axis (i.e., the width direction) of the nanorods NR1, NR2, NR3, NR4 and NR5 makes no or weak electromagnetic resonance. Accordingly, with a change in rotation angle θ_{R} of the nanorods NR1, NR2, NR3, NR4 and NR5, the sub-metasurface SM is able to operate as a polarization selective diffraction element that diffracts only the polarized light in the same direction as the major axis of the nanorods NR1, NR2, NR3, NR4 and NR5. Hence, changing the rotation angle θ_{R} of the nanorods NR1, NR2, NR3, NR4 and NR5 may make the first to fourth sub-metasurfaces SM1, SM2, SM3 and SM4 have different polarization properties.

Furthermore, as a certain phase gradient is formed in the direction of the minor axis of the nanorods NR1, NR2, NR3, NR4 and NR5, the direction of the minor axis becomes a dominant grid vector v of the sub-metasurface SM, and a dominant diffraction order (e.g., +1st diffraction) is formed in the direction of the dominant grid vector v. Accordingly, a diffraction direction of the dominant diffraction order may be determined by modulating the rotation angle θ_{R} of the nanorods NR1, NR2, NR3 NR4 and NR5. For example, when the rotation angle θ_{R} of the nanorods NR1, NR2, NR3 NR4 and NR5 is larger than zero (i.e., θ_{R}>0), it may make the (−1, 1)st diffraction dominant, and when the rotation angle θ_{R} of the nanorods is smaller than zero (i.e., θ_{R}<0), it may make the (−1, −1)st diffraction dominant. The (−1, +1)st diffraction means that the diffraction order in the direction of the x axis is −1 and the diffraction order in the direction of the y axis is +1. Similarly, the (−1, −1)st diffraction means that the diffraction order in the direction of the x axis is −1 and the diffraction order in the direction of the y axis is −1. The direction of the x axis is the length direction of the waveguide 110, and the direction of the y axis is a direction perpendicular to the x axis on the surface of the waveguide 110.

Furthermore, diffraction efficiency of the sub-metasurface SM may be controlled by controlling the intensity of the electromagnetic resonance with modulation of the length l and the width w of the nanorods NR1, NR2, NR3, NR4 and NR5.

As such, by controlling at least one of the length l, the width w and the rotation angle θ_{R} of the nanorods NR1, NR2, NR3, NR4 and NR5, it is possible to polarization-selectively select a diffraction order (diffraction direction) and control diffraction efficiency of the sub-metasurface SM.

The anisotropic metasurface of the folding/output-coupling element 130 may be formed of a dielectric material having a relatively high refractive index to increase complex amplitude controllability by maximizing interactions with the incident light. For example, the anisotropic metasurface of the folding/output-coupling element 130 may be formed of a-Si, a-Si:H, TiO₂, GaN, etc. The irregular metasurface of the input-coupling element 120 and the anisotropic metasurface of the folding/output-coupling element 130 may be formed of the same material.

In one or more embodiments, the anisotropic metasurface of the folding/output-coupling element 130 may be manufactured with a separate metasurface film and attached to the waveguide 110, without being limited thereto. In another example, the anisotropic metasurface of the folding/output-coupling element 130 may be formed (e.g., etched or imprinted) directly on a surface of the waveguide 110 in a metasurface pattern. In another example, the anisotropic metasurface of the folding/output-coupling element 130 may be arranged inside the waveguide 110 or on both surfaces of the waveguide 110.

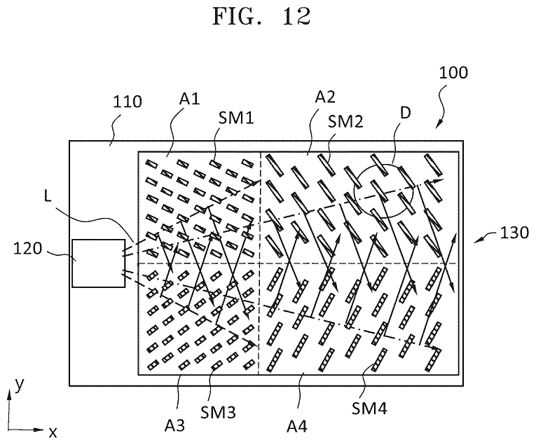

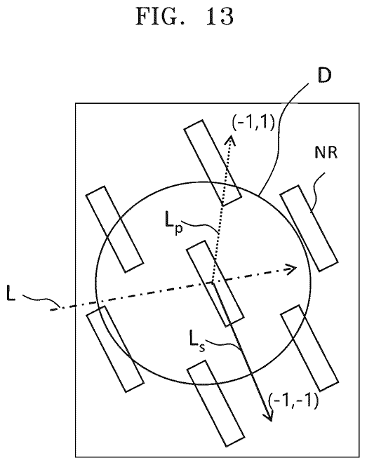

FIG. 12 is a plan view for describing operation of the image combiner 100, according to one or more embodiments, FIG. 13 is an enlarged view of area D and its vicinity of FIG. 12, and FIG. 14 is a side view for describing operation of the image combiner 100, according to one or more embodiments.

Referring to FIGS. 12 to 14, light L of a virtual image output from the display engine 20 is projected at a certain projection angle and reaches an input-coupling area where the input-coupling element 120 is arranged. The light L of the virtual image incident on the input-coupling area is diffracted through the input-coupling element 120 and enters the waveguide 110, and is propagated in the waveguide 110 by total internal reflection. The light L of the virtual image propagated in the waveguide 110 is expanded by the folding/output-coupling element 130 and exits the waveguide 110 to form the eye box EB.

The light L of the virtual image may be understood as a set of rays at different projection angles, and the light L is propagated in the waveguide 110 through total internal reflection as shown in FIG. 14, so the optical propagation length of the light being propagated differs by the diffraction angle at the input-coupling element 120. In this case, the diffraction angle corresponds to the incidence angle, so the optical propagation length of the light being propagated differs by the incidence angle.

As shown in FIG. 14, light Lₕ of incidence angle θₕ is diffracted at a relatively large diffraction angle from the input-coupling element 120, so the number of times of hitting the folding/output-coupling element 130 and being diffracted in the waveguide 110 is relatively small and the optical propagation length is relatively short. Light Lₗ of incidence angle θₗ is diffracted at a relatively small diffraction angle from the input-coupling element 120, so the number of times of hitting the folding/output-coupling element 130 and being diffracted in the waveguide 110 is relatively large and the optical propagation length is relatively long.

In the one or more embodiments, the anisotropic metasurface is optimized such that the folding/output-coupling element 130 makes the x-axis polarized light have the highest diffraction efficiency for the incidence angle θₕ (the one with the short optical propagation length) and makes the y-axis polarized light have the highest efficiency for the incidence angle θ1 (the one with the long optical propagation length). The first and third sub-areas A1 and A3 rotate the nanostructures (nanorods) to the x-axis direction to increase the diffraction efficiency for the x-axis polarized light, and the second and fourth sub-areas A2 and A4 increase the diffraction efficiency for the y-axis polarized light by rotating the nanostructures to the y-axis direction. Furthermore, rotation angles of the nanostructures (nanorods) are determined to diffract the light in the waveguide 110 only to the eye box EB. The light Lₗ of the incidence angle θₗ entering the waveguide 110 through the input-coupling element 120 is diffracted in the second sub-area A2, in which case the (−1, −1)st diffracted light is diffracted to the eye box EB to form the eye box EB while the (−1, 1)st diffracted light is lost because it does not form the eye box EB. Hence, the rotation angle θ_{R} of the nanorod may be determined in a range of θ_{R}<0 to make the (−1, −1)st diffracted light be light at the dominant diffraction order in the second sub-area A2. On the other hand, the rotation angle θ_{R} of the nanorod may be determined in a range of θ_{R}>0 to make the (−1, 1)st diffracted light be light at the dominant diffraction order in the fourth sub-area A4.

As such, the image combiner 100 in the one or more embodiments forms the folding/output-coupling element 130 with the anisotropic metasurface, so that even the light output from outer portions of the folding/output-coupling area may form the eye box EB, thereby reducing light loss and enhancing light efficiency and uniformity of brightness of the image combiner 100. For example, by forming the different first to fourth sub-metasurface SM1, SM2, SM3 and SM4 in the folding/output-coupling area, lost light that fails to form the eye box EB and is discarded may be suppressed and a wide eye box EB may be secured.

Although the folding/output-coupling area divided into four areas (i.e., the first to fourth sub-areas A1, A2, A3 and A4) is illustrated in the one or more embodiments, it is not limited thereto. The size or number of the plurality of sub-areas A1, A2, A3 and A4 may be appropriately determined according to the required size of the eye box EB, diffraction efficiency of the metasurface, polarization selectivity, etc.

Although the first and third sub-areas A1 and A3 having the same size and shape and the second and fourth sub-areas A2 and A4 having the same size and shape are illustrated in FIGS. 2 and 12, embodiments are not limited thereto. The first to fourth sub-areas A1, A2, A3 and A4 may all have the same size and shape. Although the first to fourth sub-areas A1, A2, A3 and A4 are illustrated as abutting onto the neighboring areas in FIGS. 2 and 12, embodiments are not limited thereto.

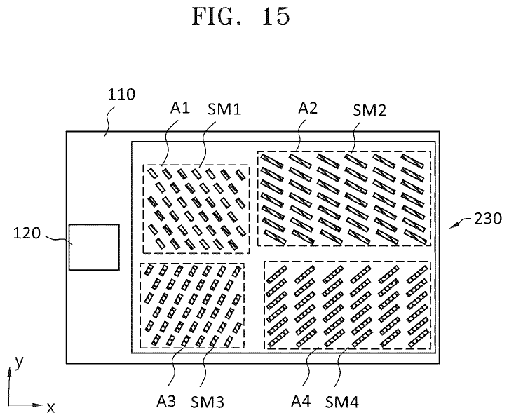

FIG. 15 illustrates a configuration of the folding/output-coupling element 230, according to one or more embodiments. Referring to FIG. 15, the folding/output-coupling element 230 may include the first to fourth sub-areas A1, A2, A3 and A4, and the first to fourth sub-areas A1, A2, A3 and A4 may have different sizes and shapes. Furthermore, the first to fourth sub-areas A1, A2, A3 and A4 may be spaced from their neighboring areas.

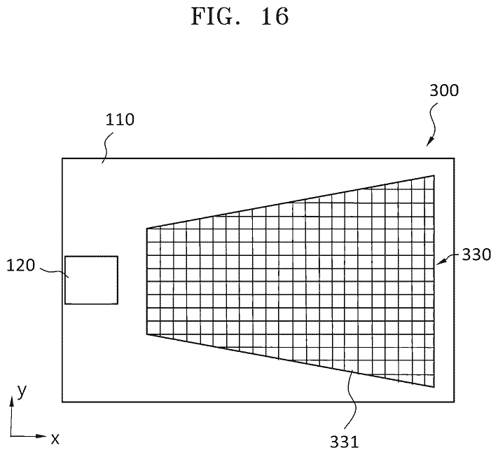

FIG. 16 illustrates a configuration of a folding/output-coupling element 330, according to one or more embodiments. Referring to FIG. 16, the folding/output-coupling element 330 may include a plurality of sub-metasurfaces 331, which may be configured such that at least one of the rotation angle, width and length of the nanostructures is gradually changed. For example, the folding/output-coupling area may be divided into many sub-areas and configured such that diffraction properties of the sub-metasurfaces 331 arranged in the sub-areas are gradually changed. In one or more embodiments, a gradual change in width and length of the nanostructures of the sub-metasurfaces 331 leads to a gradual change in diffraction efficiency of the sub-metasurfaces 331, thereby having more uniform brightness of a virtual image displayed by the image combiner 300.

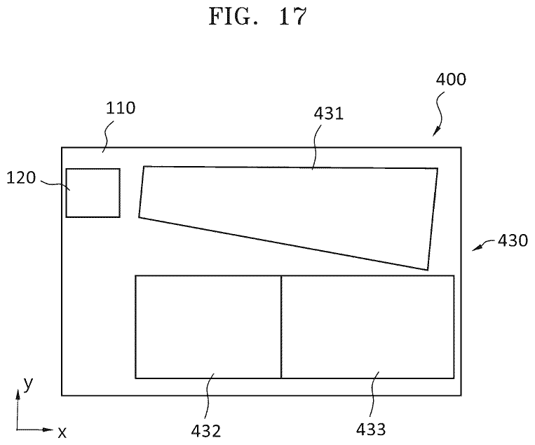

FIG. 17 illustrates a configuration of a folding/output-coupling element 430, according to one or more embodiments. Referring to FIG. 17, the folding/output-coupling element 430 includes a first sub-metasurface 431, a second sub-metasurface 432, and a third sub-metasurface 433. The first sub-metasurface 431 may be configured to perform only a folding function that transmits light L input into the waveguide 110 to the second and third sub-metasurfaces 432 and 433. As described above, length l, width w and rotation angle θ_{R} of the nanostructures such as nanorods are related to a dominant diffraction order, a diffraction direction and a diffraction efficiency, so the first sub-metasurface 431 may be allowed to perform the function of a folding coupling element by appropriately determining the length l, width w and rotation angle θ_{R} of the nanostructures of the first sub-metasurface 431. The first sub-metasurface 431 may not only simply change (i.e., fold) the path of light, but also expand the eye box EB by expanding the light L of the virtual image propagated in the waveguide 110 to a wide area of the second and third sub-metasurfaces 432 and 433. The second and third sub-metasurfaces 432 and 433 may be configured to perform a folding and output function as described above and configured to have different diffraction properties and/or polarization properties.

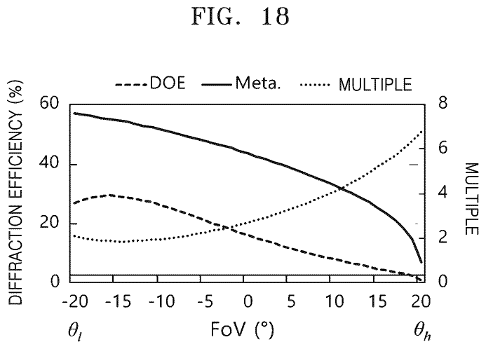

FIG. 18 is a graph showing diffraction efficiency of an image combiner, according to one or more embodiments. In the graph, DOE indicates diffraction efficiency of the related input-coupling element that uses the diffraction grating element DOE or the holographic diffraction element HOE, META indicates diffraction efficiency when an anisotropic metasurface is used for the input-coupling element, and a multiple indicates a value obtained by dividing the diffraction efficiency of the irregular metasurface by the diffraction efficiency of the related input-coupling element. Referring to FIG. 18, in a case that the irregular metasurface is used for the input-coupling element 120, the diffraction efficiency may be two to seven times higher than that of the related input-coupling element. Furthermore, in a case that an anisotropic metasurface is employed for the folding/output-coupling element, the anisotropic metasurface may diffract only desired light to a desired direction to enhance the overall light transmission efficiency by up to ten times, thereby significantly reducing the power consumption of the AR device (e.g., AR glasses), reducing the burden of a large-capacity battery and enabling enhancement of the form-factor of the AR device.

Moreover, the irregular metasurface has relatively large diffraction efficiency even with a ray of incidence angle θₕ and the anisotropic metasurface is able to transmit even a ray of incidence angle θₗ relatively far away through selective diffraction, thereby overcoming the existing limitation on the horizontal viewing angle and thus providing a viewing angle that shows immersive and wide views even with a side projection type.

Although the input-coupling element 120 and the folding/output-coupling element 130, 230, 330 or 430 are arranged on the side of the incidence surface of the waveguide 110 in the aforementioned embodiments, embodiments are not limited thereto. One or both of the input-coupling element 120 and the folding/output-coupling element 130, 230, 330 or 430 may be arranged on a side of exit surface of the waveguide 110, arranged on either surface of the waveguide 110 or arranged inside the waveguide 110.

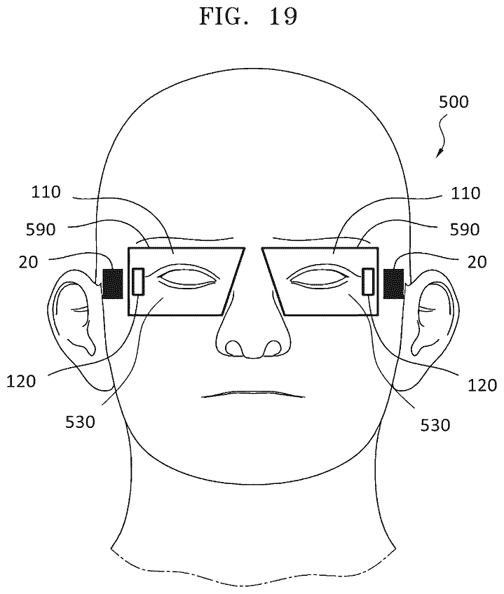

FIG. 19 schematically illustrates an AR device 500, according to one or more embodiments. Referring to FIG. 19, the AR device 500 may be AR glasses.

The AR device 500 may use the image combiner 100, 200, 300 or 400 in the aforementioned embodiments for left-eye and right-eye elements. Each image combiner 100, 200, 300 or 400 may be fixed on a frame 590.

The AR device 500 may further include the display engine 20. The display engine 20 may be located around temples of the user's head and fixed to the legs of the frame 590. The display engine 2 may be, but not exclusively, an ultra-small projector using a 2D image panel or a scanning-type ultra-small projector. Image forming and information processing for the display engine 20 may be performed directly by a computer in the AR device, or by an external electronic device such as smart phone, tablet, computer, laptop, or any other intelligent (smart) device connected to the AR device. Signal transmission between the AR device and the external electronic device may be performed through wired communication and/or wireless communication. The AR device may receive power from at least one of a built-in power source (rechargeable battery) and an external power source.

The waveguide 110 may be fixed to the rim of the frame 590. In a case that there are lenses within the rim of the frame 590, the waveguide 110 may be attached to the lens, but is not limited thereto. There may be no lens within the rim of the frame 590.

The input-coupling element 120 is located on a side of the waveguide 110 opposite the display engine 20 or the other side to input the light output from the display engine 20 into the waveguide 110. A folding/output-coupling element 530 may corresponding to the folding/output-coupling element 130, 230, 330 or 430 in the one or more embodiments. The waveguide 110 guides the incident light to the folding/output-coupling element 530, and the image combiner 100 outputs the light into a target area through the folding/output-coupling element 530. In this case, the target area may be an eye motion box of the user.

Although the image combiner and the display engine 20 are shown in FIG. 19 as each being arranged on both the left and right sides, the one or more embodiments is not limited thereto. In one or more embodiments, the image combiner and the display engine 20 may each be arranged on one of the left and right sides. In one or more embodiments, the image combiner may be arranged all over the left and right sides, and the display engine 20 may be located in the middle of the image combiner to be shared on the left and right sides or may be arranged to correspond to the respective left and right sides.

In the present disclosure, the image combiner is described as being applied to AR glasses, but the image combiner may also be applied to a near-eye display and a head-up display (HUD) capable of expressing virtual reality.

In the disclosure, the term AR device refers to a device capable of expressing AR, and encompasses not only the AR glasses in the form of glasses worn on the face of the user but also, for example, an HMD or AR helmet worn on the head, HUD, etc.

As described above, by employing the irregular metasurface for the input-coupling element 120 and the anisotropic metasurface for the folding/output-coupling element 530, the AR device 500 is able to deliver a bright virtual image with uniform brightness even at low power, thereby having a reduced size and thickness of the AR device 500 and reduced power consumption. Furthermore, the AR device 500 may provide a wide viewing angle that shows immersive and wide views.

The objective of the present disclosure is to provide a metasurface based image combiner and an AR device employing the same.

Technical objectives of the present disclosure are not limited thereto, and there may be other technical objectives.

The metasurface based image combiner and the AR device employing the same may have a wider viewing angle and enhanced brightness of a virtual image to be displayed and improve uniformity of brightness.

Several embodiments of the disclosure of the metasurface based image combiner and the AR device employing the same have been described above, but those of ordinary skill in the art will understand and appreciate that various modifications thereto can be made without departing from the scope of the disclosure. Thus, it will be apparent to those of ordinary skill in the art that the true scope of technical protection is only defined by the following claims and their equivalents.

While embodiments have been described with reference to the figures, it will be understood by those of ordinary skill in the art that various changes in form and details may be made therein without departing from the spirit and scope as defined by the following claims and their equivalents.

What is claimed is:

1. An image combiner comprising:
a waveguide;
an input-coupling element in an input-coupling area of the waveguide, the input-coupling element being configured to input light of a virtual image incident on the input-coupling area into the waveguide; and
a folding/output-coupling element in a folding/output-coupling area of the waveguide, the folding/output-coupling element being configured to form an eye box by outputting the light input into the waveguide out of the waveguide,
wherein the folding/output-coupling element is an anisotropic metasurface comprising a first sub-metasurface and a second sub-metasurface in a first sub-area and a second sub-area of the folding/output-coupling area, respectively, and
wherein the anisotropic metasurface is configured such that among rays input through different areas of the input-coupling area, a first ray having a first incidence angle is diffracted by the first sub-metasurface to be directed to the eye box and a second ray having a second incidence angle, which is different from the first incidence angle, is diffracted by the second sub-metasurface to be directed to the eye box.

2. The image combiner of claim 1, wherein the first sub-metasurface comprises an array of a plurality of first nanostructures at a first rotation angle in the first sub-area,
wherein the second sub-metasurface comprises an array of a plurality of second nanostructures at a second rotation angle, which is different from the first rotation angle, in the second sub-area, and
wherein the first rotation angle and the second rotation angle respectively determine a dominant diffraction order of the first ray diffracted in the first sub-area and a dominant diffraction order of the second ray diffracted in the second sub-area.

3. The image combiner of claim 2, wherein the plurality of first nanostructures and the plurality of second nanostructures are nanorods on the first sub-area and the second sub-area, respectively.

4. The image combiner of claim 1, wherein the first sub-metasurface comprises an array of a plurality of first nanostructures in the first sub-area,
wherein the second sub-metasurface comprises an array of a plurality of second nanostructures in the second sub-area, and
wherein a size of each first nanostructure of the plurality of first nanostructures and a size of each second nanostructure of the plurality of second nanostructures are determined such that brightness in the first sub-area is equal to brightness in the second sub-area.

5. The image combiner of claim 1, wherein an optical propagation length of a ray with the first incidence angle in the waveguide is shorter than an optical propagation length of a ray with the second incidence angle in the waveguide, and
wherein a diffraction efficiency of the first sub-area is higher than a diffraction efficiency of the second sub-area.

6. The image combiner of claim 1, wherein the first sub-area is nearer to the input-coupling element than the second sub-area.

7. The image combiner of claim 1, wherein the folding/output-coupling element comprises a plurality of sub-metasurfaces, and at least one sub-metasurface of the plurality of sub-metasurfaces is a folding coupling element configured to transmit light input into the waveguide to sub-metasurfaces other than the at least one sub-metasurface of the plurality of sub-metasurfaces.

8. The image combiner of claim 1, wherein the folding/output-coupling area comprises a plurality of sub-areas, and at least one sub-area of the plurality of sub-areas has a different form than sub-areas other than the at least one sub-area of the plurality of sub-areas.

9. The image combiner of claim 1, wherein the folding/output-coupling element comprises a plurality of sub-metasurfaces, and at least one of a rotation angle, a width, and a length of nanostructures of the plurality of sub-metasurfaces is gradually changed.

10. The image combiner of claim 1, wherein the anisotropic metasurface is formed of at least one of a-Si, a-Si:H, TiO2, and GaN.

11. The image combiner of claim 1, wherein the first incidence angle is an incidence angle of a ray having an optical propagation length that is longer than optical propagation lengths among rays input to and propagated in the waveguide, and the second incidence angle is an incidence angle of a ray having an optical propagation length that is shorter than optical propagation lengths among the rays input to and propagated in the waveguide.

12. The image combiner of claim 11, wherein the input-coupling element has a maximum diffraction efficiency for polarized light in a first direction from the first ray with the first incidence angle and has a maximum diffraction efficiency for polarized light in a second direction perpendicular to the first direction from the second ray with the second incidence angle, and
wherein the first sub-metasurface has a maximum diffraction efficiency for the polarized light in the first direction, and the second sub-metasurface has a maximum diffraction efficiency for the polarized light in the second direction.

13. The image combiner of claim 1, wherein the input-coupling element is an irregular metasurface comprising a plurality of irregular unit structures periodically on a two-dimensional (2D) plane, each irregular unit structure of the plurality of irregular unit structures having a non-periodic irregular pattern.

14. An augmented reality (AR) device comprising:
a display engine configured to output light of an image; and
an image combiner comprising:
a waveguide;
an input-coupling element in an input-coupling area of the waveguide, the input-coupling element being configured to input light of a virtual image incident on the input-coupling area into the waveguide; and
a folding/output-coupling element in a folding/output-coupling area of the waveguide, the folding/output-coupling element being configured to form an eye box by outputting the light input into the waveguide out of the waveguide,
wherein the folding/output-coupling element is an anisotropic metasurface comprising a first sub-metasurface and a second sub-metasurface in a first sub-area and a second sub-area of the folding/output-coupling area, respectively,
wherein the anisotropic metasurface is configured such that among rays input through different areas of the input-coupling area, a first ray having a first incidence angle is diffracted by the first sub-metasurface to be directed to the eye box and a second ray having a second incidence angle, which is different from the first incidence angle, is diffracted by the second sub-metasurface to be directed to the eye box, and
wherein the image combiner is configured to guide the light output from the display engine into a target area that is the eye box.

15. The AR device of claim 14, wherein the AR device comprises AR glasses comprising a left-eye element and a right-eye element corresponding to left and right eyes of a user, respectively, and
wherein each of the left-eye element and the right-eye element comprises the display engine and the image combiner.

16. The AR device of claim 14, wherein the first sub-metasurface comprises an array of a plurality of first nanostructures at a first rotation angle in the first sub-area,
wherein the second sub-metasurface comprises an array of a plurality of second nanostructures at a second rotation angle, which is different from the first rotation angle, in the second sub-area, and
wherein the first rotation angle and the second rotation angle respectively determine a dominant diffraction order of the first ray diffracted in the first sub-area and a dominant diffraction order of the second ray diffracted in the second sub-area.

17. The AR device of claim 16, wherein the plurality of first nanostructures and the plurality of second nanostructures are nanorods on the first sub-area and the second sub-area, respectively.

18. The AR device of claim 14, wherein the first sub-metasurface comprises an array of a plurality of first nanostructures in the first sub-area,
wherein the second sub-metasurface comprises an array of a plurality of second nanostructures in the second sub-area, and
wherein a size of each first nanostructure of the plurality of first nanostructures and a size of each second nanostructure of the plurality of second nanostructures are determined such that brightness in the first sub-area is equal to brightness in the second sub-area.

19. The AR device of claim 14, wherein an optical propagation length of a ray with the first incidence angle in the waveguide is shorter than an optical propagation length of a ray with the second incidence angle in the waveguide, and
wherein a diffraction efficiency of the first sub-area is higher than a diffraction efficiency of the second sub-area.

20. The AR device of claim 14, wherein the first sub-area is nearer to the input-coupling element than the second sub-area.
